(19) United States
(12) Patent Application Publication
(10) Pub. No.: US 2020/0250967 A1
(43) Pub. Date: Aug. 6, 2020

(54) SYSTEM AND METHOD FOR FACILITATING COMMUNICATION BETWEEN VEHICLES

(71) Applicant: Simon Benjamin Grunfeld, Rockville Centre, NY (US)

(72) Inventor: Simon Benjamin Grunfeld, Rockville Centre, NY (US)

(21) Appl. No.: 16/582,559

(22) Filed: Sep. 25, 2019

Related U.S. Application Data
(60) Provisional application No. 62/801,915, filed on Feb. 6, 2019.

(51) Int. Cl. G08G 1/01; G08G 1/16; G08G 1/0967; H04W 4/46; H04W 4/02; H04L 29/08

(52) U.S. Cl. CPC G08G 1/0112; G08G 1/163; H04L 67/12; H04W 4/46; H04W 4/023; G08G 1/096791

(57) ABSTRACT

A platform for facilitating communication between vehicles includes at least one processor, at least one memory, at least one communication interface for communicating over a network, and a plurality of program instructions stored in the at least one memory. User accounts are loaded to the at least one memory of the platform. Each of the user accounts is linked to a corresponding vehicle. The platform receives a request from a remote computing device of a requestor of one of the user accounts. The platform then identifies at least one recipient of the user accounts to send the request by matching criteria. The platform then broadcasts, an offer to a remote computing device of the at least one recipient. The offer identifies the corresponding vehicle of the requestor and further includes a prompt to accept or deny the request.

### CROSS-REFERENCE TO RELATED APPLICATION

This application claims the benefit of priority of U.S. provisional application No. 62/801,915, filed Feb. 6, 2019, the contents of which are herein incorporated by reference.

### BACKGROUND OF THE INVENTION

The present invention relates to communication between vehicles and, more particularly, to a system and method for facilitating wireless communication between vehicles.

Drivers value their own personal time above others. This creates higher traffic volumes, risky driving habits, and overall unsafe driving conditions. Vehicle operators have no means to provide incentives or to broadcast their intention to offer incentives to other drivers on the road. All communications between operators are mostly done through traditional methods (i.e. light and hand signaling).

As can be seen, there is a need for an improved system and method for facilitating wireless communication between vehicles.

### SUMMARY OF THE INVENTION

In one aspect of the present invention, a system for facilitating communication between vehicles, comprises: at least one processor; at least one memory; at least one communication interface for communicating over a network; and a plurality of program instructions stored in the at least one memory that, when executed by the at least one processor, cause the at least one processor to: load user accounts to the at least one memory, wherein each of the user accounts is linked to a corresponding vehicle; receive, over the network, a request from a remote computing device of a requestor of one of the user accounts; identify at least one recipient of the user accounts to send the request by matching criteria comprising a location of the requestor and the at least one recipient, a vector of the requestor and the at least one recipient, and a nature of the request; broadcast, over the network, an offer to a remote computing device of the at least one recipient, wherein the offer identifies the corresponding vehicle of the requestor and further comprises a prompt to accept or deny the request.

In another aspect of the present invention, a computer-implemented method for facilitating communication between vehicles, comprises: loading user accounts to a computer memory, wherein each of the user accounts is linked to a corresponding vehicle; receiving, over a network, a request from a remote computing device of a requestor of one of the user accounts; identifying at least one recipient of the user accounts to send the request by matching criteria comprising a location of the requestor and the at least one recipient, a vector of the requestor and the at least one recipient, and a nature of the request; and broadcasting, over the network, an offer to a remote computing device of the at least one recipient, wherein the offer identifies the corresponding vehicle of the requestor and further comprises a prompt to accept or deny the request.

These and other features, aspects and advantages of the present invention will become better understood with reference to the following drawings, description and claims.

### BRIEF DESCRIPTION OF THE DRAWINGS

FIG. 1 is a schematic view of an embodiment of the present invention;

FIG. 2 is a schematic view of an embodiment of the present invention;

FIG. 3 is a schematic view of an embodiment of the present invention; and

FIG. 4 is a schematic view of an embodiment of the present invention.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

The present invention includes a system and method that allows vehicle operators to reward and accept rewards from other drivers, through an exchange of value based on acceptance of offers. The system works by integrating Navigation, Rules-based system, geo-location tracking, and user engagement, to give or take value from users, based on the transaction details. The present invention allows vehicle operators to communicate intentions and exchange value in real time, which allows for a reduction in traffic, speeding, and overall friendlier driving experience.

The system of the present invention is a real-time exchange of value, based on effort given between operators who have no personal connection between each other. The present invention improves user experience, by allowing users to give and receive value, in real-time, based on their location, direction and ability to accept offers from other users. This incentivization model is key to improving the driving experience. This is an improvement over current communication standards involving vehicle lights and physical signaling to other drivers, as the reward-based system allows for users to incentivize their requests in real time. There is an immutable ledger based back end, which records all actions, and facilitates the transfer of value, for operators who accept and perform as per the offer they accepted.

The present invention includes a system and method for facilitating communication between vehicles. The present invention is a platform that includes at least one processor, at least one memory, at least one communication interface for communicating over a network, and a plurality of program instructions stored in the at least one memory. User accounts are loaded to the at least one memory of the platform. Each of the user accounts is linked to a corresponding vehicle. The platform receives, over the network, a request from a remote computing device of a requestor of one of the user accounts. The platform then identifies at least one recipient of the user accounts to send the request by matching criteria. The criteria includes at least a location of the requestor and the at least one recipient, a vector of the requestor and the at least one recipient, and a nature of the request. The platform then broadcasts, over the network, an offer to a remote computing device of the at least one recipient. The offer identifies the corresponding vehicle of the requestor and further includes a prompt to accept or deny the request.

Users use and interact with the platform using remote computing devices each having a processer, a memory, a user interface, and a communications interface. The platform may be supported by a server. The computing devices send and retrieve data from the server over a wireless network. For example, the remote computing devices of user accounts broadcast live feeds of location and vector data via a global positioning system and/or a telecommunications network. The computing devices may be remote from the server and may include, but are not limited to, a tablet, a smart phone, a smart speaker, or an onboard vehicle computing system.

The user interface includes hardware, software, or both providing one or more interfaces for communication between the computing devices and the server. As an example and not by way of limitation, a user interface may include a keyboard, keypad, microphone, monitor, mouse, printer, scanner, speaker, still camera, stylus, touchscreen, trackball, video camera, another suitable device or a combination of two or more of these.

In certain embodiments, the computing devices and the server may execute on any suitable operating system such as IBM's zSeries/Operating System (z/OS), MS-DOS, PC-DOS, MAC-OS, WINDOWS, UNIX, OpenVMS, an operating system based on LINUX, or any other appropriate operating system, including future operating systems. In certain embodiments, the server may be a web server running web server applications such as Apache, Microsoft's Internet Information Server™, and the like. The web server may be part of a cloud based network.

In particular embodiments, the computing devices and the server include a processor, a memory, and a communications interface. In particular embodiments, the processor includes hardware for executing instructions, such as those making up a computer program. The memory is for storing instructions such as computer program(s) for the processor to execute, or data for processor to operate on. The memory may include an HDD, a floppy disk drive, flash memory, an optical disc, a magneto-optical disc, magnetic tape, a Universal Serial Bus (USB) drive, a solid-state drive (SSD), or a combination of two or more of these. The memory may include removable or non-removable (or fixed) media, where appropriate. The memory may be internal or external to the computing device, where appropriate. In particular embodiments, the memory is non-volatile, solid-state memory.

The memory of the server may be a database for mass storage for data. As an example and not by way of limitation, the database may include an HDD, a floppy disk drive, flash memory, an optical disc, a magneto-optical disc, magnetic tape, a Universal Serial Bus (USB) drive, a solid-state drive (SSD), or a combination of two or more of these. The database may include removable or non-removable (or fixed) media, where appropriate. The database may be internal or external to server, where appropriate. In particular embodiments, the database is non-volatile, solid-state memory.

The communication interfaces include hardware, software, or both providing one or more interfaces for communication (e.g., packet-based communication) between the server and one or more other computing devices or one or more networks. As an example and not by way of limitation, communication interface may include a network interface controller (NIC) or network adapter for communicating with an Ethernet or other wire-based network or a wireless NIC (WNIC) or wireless adapter for communicating with a wireless network, such as a WI-FI network. This disclosure contemplates any suitable network and any suitable communication interface. As an example and not by way of limitation, the server and computing devices may communicate with an ad hoc network, a personal area network (PAN), a local area network (LAN), a wide area network (WAN), a metropolitan area network (MAN), or one or more portions of the Internet or a combination of two or more of these. One or more portions of one or more of these networks may be wired or wireless. As an example, the server and computing devices may communicate with a wireless PAN (WPAN) (e.g., a BLUETOOTH WPAN), a WI-FI network, a WI-MAX network, a cellular telephone network (e.g., a Global System for Mobile Communications (GSM) network), or other suitable wireless network or a combination of two or more of these. The server and computing devices may include any suitable communication interface for any of these networks, where appropriate.

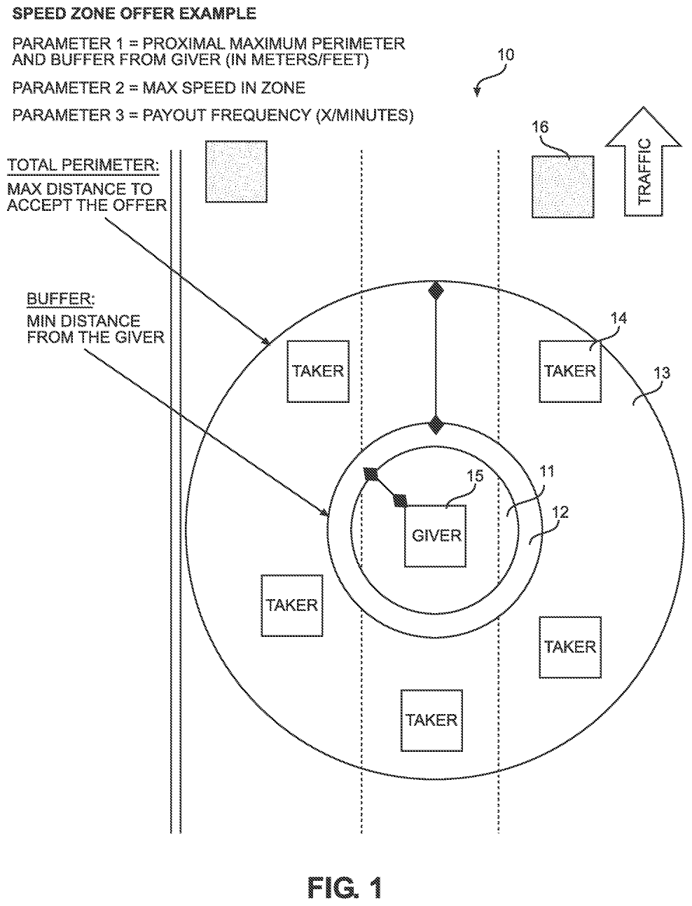

FIG. 1 illustrates an example of a communication between a vehicle and surrounding vehicles to slow down. The platform receives, over the network, a request from a remote computing device of a requestor 15 of one of the user accounts for surrounding vehicles to slow down. The platform then identifies at least one recipient 14 of the user accounts to send the request by matching criteria. The criteria includes a location of the requestor 15 and the at least one recipient 15, a vector of the requestor 15 and the at least one recipient 14, and a nature of the request. The nature of the request in this particular example involves vehicles within certain proximity of the requestor. As illustrated in FIG. 1, the platform determines a first parameter 11, a second parameter 12 and a third parameter 13. The platform then broadcasts, over the network, an offer to the remote computing devices of the plurality of recipients 14 within the third parameter 13. Users outside of the parameters 16 are not notified. The offer identifies the corresponding vehicle of the requestor 15 and further prompts to the recipients 14 accept or deny the request. Recipients 14 may accept the offer and reduce the speed when driving within the third parameter 13.

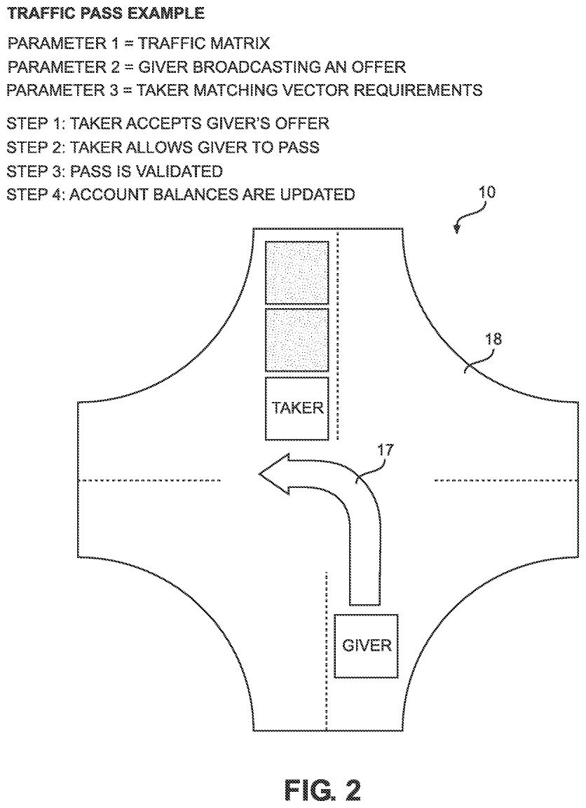

FIG. 2 illustrates an example of a communication between a vehicle and surrounding vehicles to assist with a turn 17. The platform receives, over the network, a request from a remote computing device of a requestor 15 of one of the user accounts for an oncoming vehicle to stop and allow the requestor 15 to take a left turn 17. The platform then identifies a recipient 14 of the user accounts to send the request by matching criteria. The criteria at least includes a location of the requestor 15 and the at least one recipient 14, a vector of the requestor 15 and the at least one recipient 14, and a nature of the request. The nature of the request in this example is finding vehicles that are approaching the requestor 15. As illustrated in FIG. 2, the platform determines who is coming towards the requestor at a particular intersection 18. The platform then broadcasts, over the network, an offer to the remote computing device of the recipients 14 that meets these criteria. The offer identifies the corresponding vehicle of the requestor 15 and further prompts to the recipients 14 to accept or deny the request. Recipients 14 may accept the offer, stop, and allow the requestor 15 to turn 17.

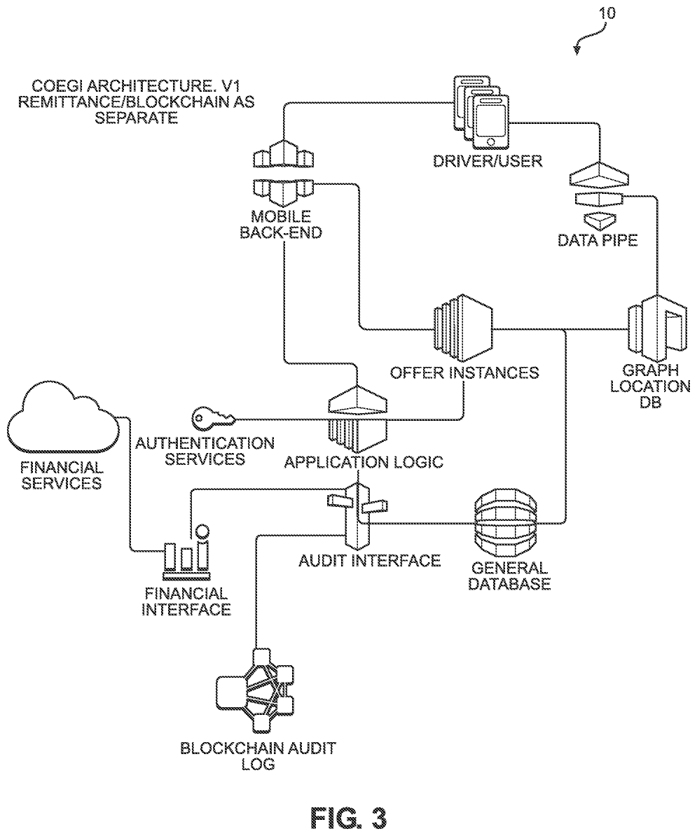

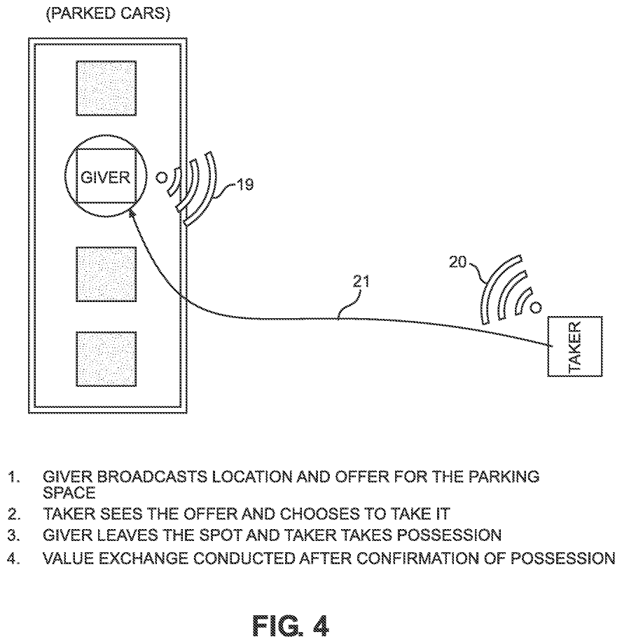

Referring to FIG. 3, the platform 10 of the present invention may include a monetary exchange from the requestor to the recipients that accept the offer and complete the request. In such embodiments, the platform 10 of the present invention validates a completion of the request by analyzing the locations and the vectors of the requestor and the recipient after the offer is accepted. For example, a request may be to have the recipient stop and allow the requestor to take a left turn. The platform determines whether the recipient stopped and whether the requestor turned in front of them using location and vector data sent from the vehicles. The platform 10 then transfers the monetary value from the user account of the requestor to the user account of the recipient if the completion of the request is validated. The transfers of monetary values are recorded using at least one of a database schema and a ledger. Referring to FIG. 4, the present invention may be used for parking spots. A giver 19 of the parking spot broadcasts their location. The taker 20 of the parking spot picks up the broadcast of the location and broadcasts a request to the giver 19. The giver 19 and the taker 20 may then connect over the network to coordinate the exchange of the parking spot. Once the taker 20 parks in the parking spot, a monetary transaction from the taker 20 to the giver 19 occurs.

A network-based platform is created which enables real-time user engagement and payment processing. The platform performs user identification and account management. The present invention includes GPS and Navigation integration to perform/confirm location management and vectoring. A traffic Matrix analysis is done to verify flow and possible scenarios. The platform confirms options and requests, with users, based on the location, matrix and vectoring of users. The platform validates offers based on the platform rules and user engagement; the platform determines all parties involved have matched the requirements. The platform further manages the account balances between users, to debit and credit users accordingly. The platform is integrated with DB schema or Ledger, for the purpose of recording usage data.

Users use the present invention by way of mobile or embedded stock platform (car manufacturer), to provide them with a safer and easier means to communicate intentions to other vehicle operators, and even compensate other users for their efforts. Utilizing a real-time analysis and value exchange between operators, options and requests can be broadcasted over the system, allowing anyone qualifying to accept the option, to gain value by doing so. When a driver wants to pass in front, the system rewards the driver that lets the other pass first. By holding a parking spot, the giver of the spot is rewarded when they leave. By slowing down on the highway, while in a certain proximal distance from the user, other operators are compensated over that period of time.

It should be understood, of course, that the foregoing relates to exemplary embodiments of the invention and that modifications may be made without departing from the spirit and scope of the invention as set forth in the following claims.

What is claimed is:

1. A system for facilitating communication between vehicles, comprising:
at least one processor;
at least one memory;
at least one communication interface for communicating over a network; and
a plurality of program instructions stored in the at least one memory that, when executed by the at least one processor, cause the at least one processor to:
load user accounts to the at least one memory, wherein each of the user accounts is linked to a corresponding vehicle;
receive, over the network, a request from a remote computing device of a requestor of one of the user accounts;
identify at least one recipient of the user accounts to send the request by matching criteria comprising a location of the requestor and the at least one recipient, a vector of the requestor and the at least one recipient, and a nature of the request;
broadcast, over the network, an offer to a remote computing device of the at least one recipient, wherein the offer identifies the corresponding vehicle of the requestor and further comprises a prompt to accept or deny the request.

2. The system for facilitating communication between vehicles of claim 1, wherein the at least one recipient is a plurality of recipients, wherein one or more recipients are capable of accepting depending on the request.

3. The system for facilitating communication between vehicles of claim 1, wherein if the at least one recipient accepts the request, the processor validates a completion of the request by analyzing the locations and the vectors of the requestor and the recipient after the offer is accepted.

4. The system for facilitating communication between vehicles of claim 3, wherein the offer further comprises a monetary value for the completion of the request.

5. The system for facilitating communication between vehicles of claim 4, wherein the processor transfers the monetary value from the user account of the requestor to the user account of the recipient if the completion of the request is validated.

6. The system for facilitating communication between vehicles of claim 5, wherein the transfers of monetary values are recorded using at least one of a database schema and a ledger.

7. The system for facilitating communication between vehicles of claim 1, wherein remote computing devices of user accounts broadcast live feeds of location and vector data via at least one of a global positioning system and a telecommunications network.

8. A computer-implemented method for facilitating communication between vehicles, comprising:
loading user accounts to a computer memory, wherein each of the user accounts is linked to a corresponding vehicle;
receiving, over a network, a request from a remote computing device of a requestor of one of the user accounts;
identifying at least one recipient of the user accounts to send the request by matching criteria comprising a location of the requestor and the at least one recipient, a vector of the requestor and the at least one recipient, and a nature of the request; and
broadcasting, over the network, an offer to a remote computing device of the at least one recipient, wherein the offer identifies the corresponding vehicle of the requestor and further comprises a prompt to accept or deny the request.

9. The method of claim 8, wherein the at least one recipient is a plurality of recipients, wherein one or more recipients are capable of accepting depending on the request.

10. The method of claim 8, wherein if the at least one recipient accepts the request, further comprising a step of:
validating a completion of the request by analyzing the locations and the vectors of the requestor and the recipient after the offer is accepted.

11. The method of claim 10, wherein the offer further comprises a monetary value for the completion of the request.

12. The method of claim 10, further comprising a step of: transferring the monetary value from the user account of the requestor to the user account of the recipient if the completion of the request is validated.

13. The method of claim 12, wherein the transfers of monetary values are recorded using at least one of a database schema and a ledger.

14. The method of claim 8, wherein remote computing devices of user accounts broadcast live feeds of location and vector data via at least one of a global positioning system and a telecommunications network.
